(19) United States
(12) Patent Application Publication
(10) Pub. No.: US 2015/0158447 A1
(43) Pub. Date: Jun. 11, 2015

(54) VEHICLE EMERGENCY CALL APPARATUS

(71) Applicant: DENSO CORPORATION, Kariya-city, Aichi-pref. (JP)

(72) Inventor: Toshihito NONAKA, Chiryu-shi (JP)

(21) Appl. No.: 14/561,444

(22) Filed: Dec. 5, 2014

(30) Foreign Application Priority Data
Dec. 6, 2013 (JP) 2013-253136

(51) Int. Cl. B60R 21/0136; B60R 21/013

(52) U.S. Cl. CPC B60R 21/0136; B60R 21/013; B60R 2021/01317

(57) ABSTRACT

In a vehicle emergency call apparatus, a call determining unit determines whether or not a degree of damage to at least one occupant seated in at least one vehicle seat is a predetermined degree required for an emergency call to be made, based on a detected impact magnitude applied to a vehicle and a predetermined impact magnitude. The call determining unit sets the predetermined impact magnitude to a first impact magnitude when a belt-wearing detector detects that at least one occupant seated in the at least one vehicle seat does not wear the seatbelt, and sets the predetermined impact magnitude to a second impact magnitude when the belt-wearing detector detects that the at least one occupant seated in the at least one vehicle seat wears the seatbelt. The first impact magnitude is set to be smaller than the second impact magnitude.

### CROSS-REFERENCE TO RELATED APPLICATION

This application is based on and claims the benefit of priority from Japanese Patent Application No. 2013-253136, filed Dec. 6, 2013, the disclosure of which is incorporated herein in its entirety by reference.

### BACKGROUND

1. Technical Field

The present invention relates to a vehicle emergency call apparatus that makes an emergency call during an emergency, such as a vehicular accident.

2. Related Art

There is a related art that relates to a vehicle emergency call apparatus (refer to, for example, JP-A-2007-538297). In the event of a vehicular accident, the vehicle emergency call apparatus estimates the damage to occupants based on the acceleration of the vehicle. The vehicle emergency call apparatus then transmits information related to the damage to the occupants to a rescue center for emergency medical treatment. In the related art, the seats in the vehicle are provided with seat mats. The seat mat detects whether or not an occupant is seated on the seat or detects the weight of the occupant on the seat to generate information to be used when notifying the rescue center.

As a result, in the above-described related art, when rescue is required in an accident or the like, in addition to information related to the damage to the occupant, information, such as the number of occupants and the age, build, and the like of each occupant, can be transmitted to a rescue center that is under contract in advance. Therefore, an accurate notification can be given of the degree of injury (harm) to the occupants and the criticality (level of urgency) of the rescue. The rescue center can efficiently perform a rescue operation in a short amount of time for a user who has requested rescue.

When a vehicular accident or the like occurs, the degree of damage to an occupant varies depending on whether or not the vehicle is provided with a protective means. For example, an airbag unit, a seatbelt pretensioner unit, and the like are applicable as the protective means. In the above-described related art, the type of airbag unit and the type of pretensioner unit are also used to estimate the degree of damage to the occupant after an accident.

Here, wearing a seatbelt is highly effective as a protective means against vehicular accidents and the like. As a result of an occupant of a vehicle wearing a seatbelt, the body of the occupant can be firmly held in relation to the acceleration of the vehicle during a collision. The occupant can be prevented from being thrown out of the vehicle or colliding with interior components of the vehicle. It is well known that the seatbelt reduces damage to the occupant.

However, there has been no technology for estimating the degree of damage to an occupant based on whether or not the occupant is wearing a seatbelt and determining the criticality (level of urgency) of the call, when an emergency call is made to a rescue center in the event of a vehicular accident or the like. Even in the above-described related art, whether or not the seatbelt is worn is not considered when estimating the degree of damage to the occupant.

### SUMMARY

It is thus desired to provide a vehicle emergency call apparatus that is capable of accurately estimating the degree of damage to an occupant in a vehicular accident, accurately determining the criticality of an emergency situation, and giving notification.

An exemplary embodiment provides a vehicle emergency call apparatus that includes an impact amount detector, a seating detector, a call determining unit, and a calling unit. The impact amount detector detects an impact magnitude applied to a vehicle from outside of the vehicle. The seating detector detects whether or not at least one occupant is seated in at least one seat in the vehicle. The call determining unit determines whether or not a degree of damage to the occupant seated in the vehicle seat is a degree required for an emergency call to be made, based on the detected magnitude of the impact applied to the vehicle and a predetermined impact magnitude. The calling unit makes an emergency call to a rescue center, when it is determined that the degree of damage to the at least one occupant is the degree for the emergency call to be made, based on determination results of the call determining unit.

The vehicle emergency call apparatus also includes a belt-wearing detector that detects whether or not the at least occupant seated in the vehicle seat wears a seatbelt. The call determining unit sets the predetermined impact magnitude to a first impact magnitude (IM1), when the belt-wearing detector detects that the at least one occupant seated in the at least one vehicle seat does not wear the seatbelt. The call determining unit sets the predetermined impact magnitude to a second impact magnitude (IM2), when the belt-wearing detector detects that the at least one occupant seated in the at least one vehicle seat wears the seatbelt. The first impact magnitude is set to be smaller than the second impact magnitude.

In the above-described configuration, when the belt-wearing detector detects that an occupant seated in a vehicle seat does not wear a seatbelt, the call determining unit sets the impact magnitude for determining that the damage are to a degree that an emergency call should be made to be lower than that when the occupant wears the seatbelt. Therefore, when the occupant does not wear the seatbelt, an estimation is made that the degree of damage to the occupant is high. The emergency call can be more easily made. Therefore, in a vehicular accident or the like, the criticality of the emergency situation can be accurately determined and an emergency call can be made.

### BRIEF DESCRIPTION OF THE DRAWINGS

In the accompanying drawings:

FIG. 1 is a planar view of a vehicle in which a vehicle emergency call apparatus according to a first embodiment of the present invention is mounted;

FIG. 2 is a block diagram of the vehicle emergency call apparatus;

FIG. 3 is a diagram of a flowchart of an emergency call method of the vehicle emergency call apparatus according to the first embodiment;

FIG. 4 is a planar view of a vehicle for explaining an emergency call method of a vehicle emergency call apparatus according to a second embodiment;

FIG. 5 is a diagram of a table used in the emergency call method according to the second embodiment;

FIG. 6 is a diagram of a flowchart of the emergency call method according to the second embodiment; and

FIG. 7 is a diagram of a flowchart of an emergency call method according to a third embodiment.

### DESCRIPTION OF THE EMBODIMENTS

### First Embodiment

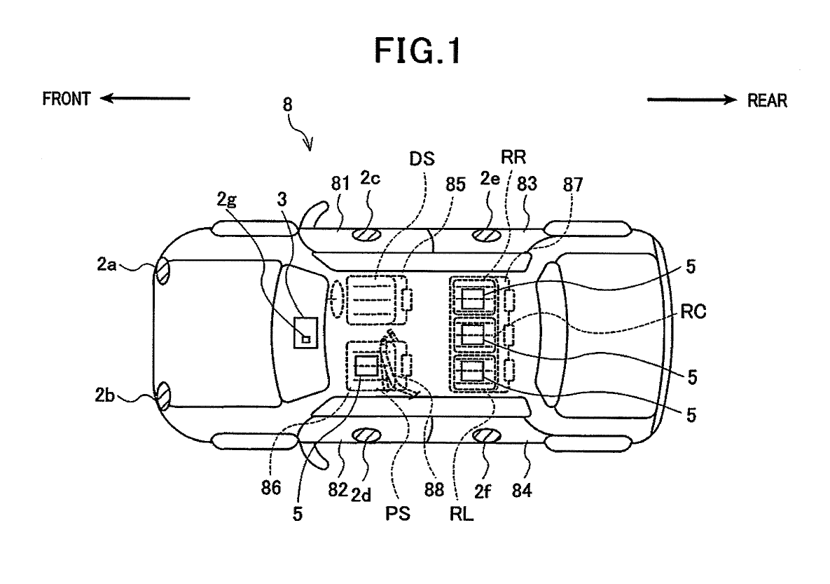

A vehicle emergency call apparatus 1 according to a first embodiment of the present invention will be described with reference to FIGS. 1 to 3.

As shown in FIG. 1, the vehicle emergency call apparatus 1 according to the present embodiment is mounted in a vehicle 8. The vehicle 8 is provided with a plurality of acceleration sensors 2a, 2b, 2c, 2d, 2e, 2f, and 2g (each correspond to an impact amount detector equivalent to impact amount detecting means). The acceleration sensors 2a, 2b, 2c, 2d, 2e, 2f, and 2g are hereinafter referred to as acceleration sensors 2 when referred to collectively. The acceleration sensors 2 may be, for example, a capacitance-type acceleration sensor, a piezo resistance-type acceleration sensor, or a heat detection-type acceleration sensor.

The pair of acceleration sensors 2a and 2b are respectively provided in the left and right areas of a front end portion of the vehicle 8. In addition, the pair of acceleration sensors 2c and 2d are respectively mounted inside a driver-side door 81 and an occupant seat-side door 82 of the vehicle 8. Furthermore, the pair of acceleration sensors 2e and 2f are respectively mounted inside a right rear door 83 and a left rear door 24 of the vehicle 8. The acceleration sensor 2g is provided within an airbag controller 3, described hereafter.

The airbag controller 3 is mounted on the lower side inside the dashboard, such as in front of the driver seat. The acceleration sensor 2g is capable of detecting acceleration in the left/right direction and front/rear direction of the vehicle 8. As the acceleration sensor 2g, a sensor that is capable of detection in the left/right direction of the vehicle 8 and a sensor that is capable of detection in the front/rear direction of the vehicle 8 may be separately provided. The acceleration sensors 2 detect the impact magnitude applied to each area of the vehicle from outside of the vehicle 8 during an accident or the like.

A driver seat 85, an occupant seat 86, and a rear seat 87 are provided inside of the vehicle 8. The driver seat 85 is provided with a driver seating DS. The occupant seat 86 is provided in a parallel with the driver seat 85 to the left of the driver seat 85. The occupant seat 86 is provided with an occupant seating PS. The rear seat 87 is set behind the driver seat 85 and the occupant seat 86.

The driver seat 85, the occupant seat 86, and the rear seat 87 correspond to vehicle seats. The driver seat 85, the occupant seat 86, and the rear seat 87 are hereinafter collectively referred to as vehicle seats 85, 86, and 87. The rear seat 87 is capable of seating three persons. The rear seat 87 is provided with a right rear seating RR, a center rear seating RC, and a left rear seating RL, in order from the right side.

The driver seating DS, the occupant seating PS, the right rear seating RR, the center rear seating RC, and the left rear seating RL correspond to seating positions. The driver seating DS, the occupant seating PS, the right rear seating RR, the center rear seating RC, and the left rear seating RL are hereinafter collectively referred to as seating positions DS, PS, RR, RC, and RL.

The driver seat 85 and the occupant seat 86 are each provided with a seatbelt unit 88 (corresponding to a seatbelt). In addition, three sets of seatbelt units 88 are provided in the rear seat 87 for the right rear seating RR, the center rear seating RC, and the left rear seating RL. In FIG. 1, only the seatbelt unit 88 of the occupant seat 86 is shown.

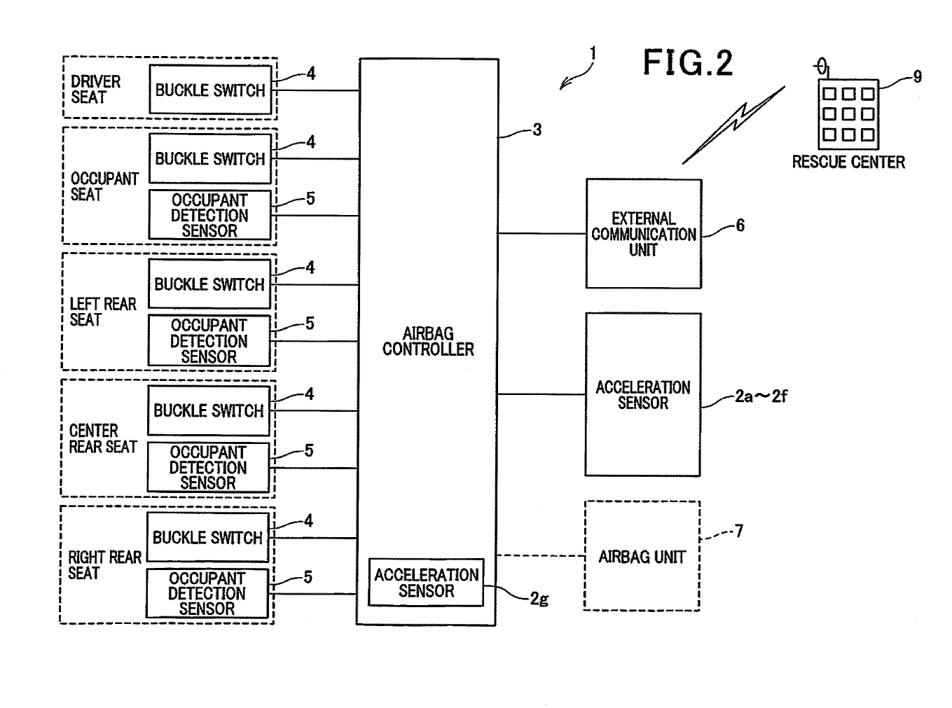

The airbag controller 3 (corresponding to a call determining unit equivalent to call determining means) shown in FIG. 2 is a control unit composed of the above-described acceleration sensor 2g, an input/output unit (not shown), a central processing unit (CPU), a random access memory (RAM), and the like. The above-described acceleration sensors 2a, 2b, 2c, 2d, 2e, and 2f are connected to the airbag controller 3. A buckle switch 4 (corresponding to a belt-wearing detector equivalent to belt-wearing detecting means) is attached to each of the above-described seatbelt units 88. Each buckle switch 4 is connected to the airbag controller 3. The buckle switch 4 is formed to be capable of detecting whether or not a seated occupant wears the seatbelt unit 88 (whether or not a tongue and a buckle are engaged).

In addition, occupant detection sensors 5 (corresponding to a seating detector equivalent to seating detecting means) are respectively mounted in the occupant seat 86 and the rear seat 87 for each seating position PS, RR, RC, and RL (see FIG. 1). According to the present embodiment, a load sensor that includes a strain gauge is used as the occupant detection sensor 5.

Each occupant detection sensor 5 is connected to the airbag controller 3. The occupant detection sensors 5 detect whether or not occupants are seated in the seating positions PS, RR, RC, and RL. The driver is obviously seated in the driver seat DS while the vehicle 8 is traveling. Therefore, the occupant detection sensor 5 is not required to be provided in the driver seat 85.

An airbag unit 7 is connected to the airbag controller 3. The airbag unit 7 is not included in the vehicle emergency call apparatus 1. The airbag unit 7 is similar to a conventional type. The airbag unit 7 is composed of an inflator, a bag, and an igniting unit (not shown). When determined that the vehicle 8 has collided based on detection signals from the above-described acceleration sensors 2, the airbag controller 3 applies a current that enables activation of the airbag unit 7.

Furthermore, an external communication unit 6 (corresponding to a calling unit equivalent to calling means) is connected to the airbag controller 3. According to the present embodiment, the external communication unit 6 is composed of a data communication module (DCM). However, the external communication unit 6 is not limited thereto and may be a mobile phone or the like.

The airbag controller 3 determines whether or not a damage degree of each occupant is a degree required for an emergency call to be made, based on the detection values from the acceleration sensors 2 and the occupant detection sensors 5, and ON/OFF signals from the buckle switches 4. When an occupant, whose damage degree is determined to be the degree required for the emergency call to be made, is present, the airbag controller 3 makes an emergency call for emergency medical treatment to a rescue center 9 outside of the vehicle, via the external communication unit 6.

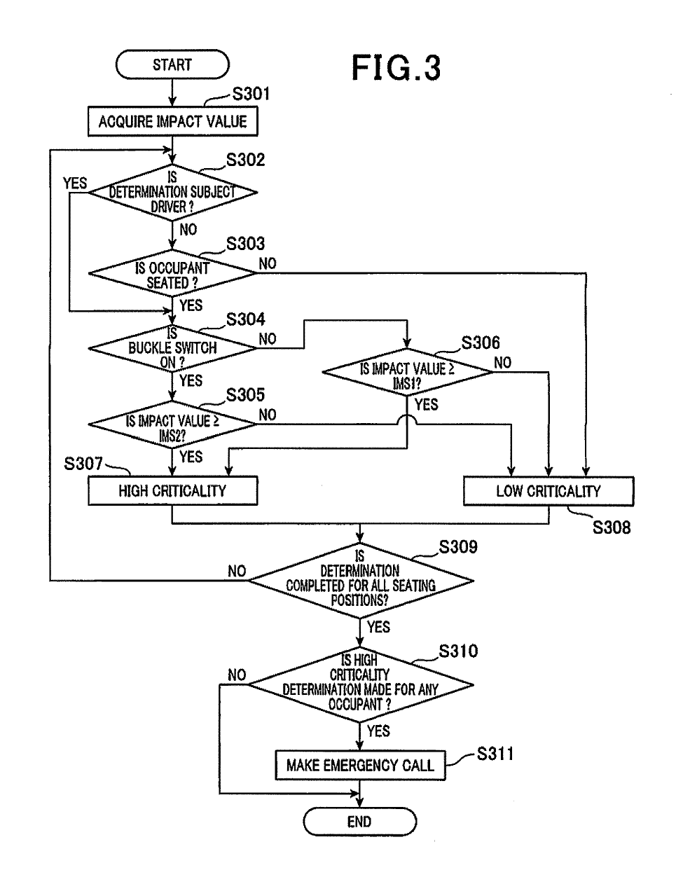

Next, an emergency call method of the vehicle emergency call apparatus 1 according to the present embodiment will be described with reference to FIG. 3. According to the present embodiment, when an accident or the like occurs, the airbag controller 3 acquires the impact magnitude (impact value) applied to the vehicle 8 from outside of the vehicle 8 through the detection values detected and transmitted from the acceleration sensors 2. At this time, when determined that a collision involving the vehicle 8 has occurred, the airbag controller 3 activates an emergency call function of the vehicle emergency call apparatus 1.

First, the airbag controller 3 acquires the impact value (step S301). Next, the airbag controller 3 determines whether or not an occupant that is the determination subject of a determination regarding whether or not an occupant is seated is the driver (step S302).

According to the present embodiment, the estimation of the degree of damage to an occupant caused by an accident is performed for each seating position, in the order of the occupant seated in the driver seating DS, the occupant seated in the occupant seating PS, the occupant seated in the right rear seating RR, the occupant seated in the center rear seating RC, and the occupant seated in the left rear seating RL.

Therefore, in a first cycle of the present flow, the degree of damage to the driver is determined. Thus, in the first cycle of the flow, step S303 is skipped. The airbag controller 3 proceeds from steps S302 to S304. The reason for this is that, because the driver is obviously on board the vehicle 8 while the vehicle 8 is traveling, as described above, detection regarding whether or not an occupant is seated is not performed for the driver seat DS.

At step S304, the airbag controller 3 determines, through the buckle switch 4, whether or not the seated occupant wears the seatbelt unit 88. When determined that the occupant (driver) wears the seatbelt unit 88, the airbag controller 3 determines whether or not the impact value of the impact applied to the vehicle 8 detected at step S301 is equal to or larger than a predetermined threshold IMS2 (corresponding to a second threshold equivalent to a second impact magnitude) (step S305).

When determined that the impact value of the impact applied to the vehicle 8 is equal to or larger than IMS2, the airbag controller 3 determines that the accident is a critical accident and the occupant is injured to a degree that an emergency call should be made. The airbag controller 3 makes the determination “high criticality” (step S307).

In addition, when determined that the impact value of the impact applied to the vehicle 8 is lower than IMS2, the airbag controller 3 determines that the degree of damage to the occupant is relatively small and makes the determination “low criticality” (step S308).

On the other hand, when determined that the seated occupant does not wear the seatbelt unit 88 at step S304, at step S306, the airbag controller 3 determines whether or not the impact value of the impact applied to the vehicle 8 is equal to or larger than a predetermined threshold IMS1 (corresponding to a first threshold equivalent to a first impact magnitude), the airbag controller 3 determines that the accident is a critical accident and the occupant is damaged with a degree required for an emergency call to be made. The airbag controller 3 makes the determination “high criticality” (step S307).

When determined that the impact value of the impact applied to the vehicle 8 is lower than IMS1, the airbag controller 3 determines that the degree of damage to the occupant is relatively small and makes the determination “low criticality” (step S308). IMS1 and IMS2 correspond to the impact magnitude for determining that a degree of damage is a degree required for an emergency call to be made.

As described above, in the present flow, the magnitude of the threshold IMS1 is set to be smaller than the magnitude of the threshold IMS2. The threshold IMS1 is used to make the determination “high criticality” indicating that damage are required for an emergency call to be made, when an occupant seated in the vehicle seat 85, 86, or 87 does not wear the seatbelt unit 88. The threshold IMS2 is used to make the determination “high criticality” indicating that damage are a degree required for an emergency call to be made, when an occupant seated in the vehicle seat 85, 86, or 87 wears the seatbelt unit 88.

After the determination “high criticality” or “low criticality” is made for the occupant seated in the driver seating DS, at step S309, the airbag controller 3 determines whether or not the determination of “high criticality” or “low criticality” regarding a seated occupant has been completed for all seating positions DS, PS, RR, RC, and RL in the vehicle 8. When determined that the determination of “high criticality” or “low criticality” regarding a seated occupant has not yet been completed for all seating positions DS, PS, RR, RC, and RL, the airbag controller 3 returns to step S302. The airbag controller 3 starts a second determination cycle for the occupant seating PS.

In the second cycle routine, the occupant seated in the occupant seating PS is not the driver. Therefore, the airbag controller 3 proceeds to step S303 and determines, through the occupant detection sensor 5, whether or not an occupant is present on the occupant seating PS. When determined that an occupant is not seated on the occupant seat PS, at step S308, the airbag controller 3 makes the determination “low criticality” and proceeds to step S309.

On the other hand, when determined that an occupant is seated in the occupant seating PS at step S303, the airbag controller 3 performs the flow from step S304 to subsequent steps in a manner similar to that for the driver seat DS, described above.

A third determination cycle, a fourth determination cycle, and a fifth determination cycle are subsequently performed for the occupants seated in the remaining seating positions RR, RC, and RL.

When determined that the determination of “high criticality” or “low criticality” regarding a seated occupant has been completed for all seating positions DS, PS, RR, RC, and RL in the vehicle 8, the airbag controller 3 proceeds to step S310. The air bag controller 3 determines whether or not there is an occupant for whom the determination “high criticality” has been made among the determination results.

When determined that there is even a single occupant for whom the determination “high criticality” has been made, among the determination results for the seating positions DS, PS, RR, RC, and RL, the airbag controller 3 makes an emergency call and gives notification of the number of occupants for whom the determination “high criticality” has been made to the rescue center 9, via the external communication unit 6 (step S311). When determined that there is not even a single occupant for whom the determination “high criticality” has been made among the determination results, the airbag controller 3 does not make an emergency call to the rescue center 9 and ends present flow (step S310).

In the vehicle emergency call apparatus 1 according to the present embodiment, the magnitude of the threshold IMS1 is set to be smaller than the magnitude of the threshold IMS2. The threshold IMS1 is used to make the determination “high criticality” indicating that damage are a degree required for an emergency call to be made, when an occupant seated in the vehicle seat 85, 86, or 87 does not wear the seatbelt unit 88. The threshold IMS2 is used to make the determination “high criticality” indicating that damage are a degree required for an emergency call to be made, when an occupant seated in the vehicle seat 85, 86, or 87 wears the seatbelt unit 88.

Therefore, the airbag controller 3 can estimate that the degree of damage to an occupant is high when the occupant does not wear the seatbelt unit 88. The emergency call can be more easily made. Therefore, when the vehicle 8 is in an accident or the like, the criticality of the emergency situation can be accurately determined and an emergency call can be made.

In addition, the external communication unit 6 gives notification of the number of occupants for whom the determination “high criticality” has been made when the emergency call is made. Therefore, the rescue center 9 that has received the call can specifically grasp the number of occupants who have a high degree of damage. The rescue center 9 can make sufficient preparations for the rescue operation in advance and carry out the operation with more efficiency.

In addition, the buckle switch 4 of the seatbelt unit 88 is used as the belt-wearing detector or detecting means for detecting whether or not the occupant wears the seatbelt unit 88. Therefore, a configuration originally provided in the seatbelt unit 88 can be used. A new configuration is not required to be provided to detect whether or not the seatbelt unit 88 is being worn.

In addition, in the emergency call method of the vehicle emergency call apparatus 1, the magnitude of the threshold IMS1 is set to be smaller than the magnitude of the threshold IMS2. The threshold IMS1 is used to make the determination “high criticality” indicating that damage is a degree required for an emergency call to be made, when an occupant seated in the vehicle seat 85, 86, or 87 does not wear the seatbelt unit 88. The threshold IMS2 is used to make the determination “high criticality” indicating that damage are a degree required for an emergency call to be made, when an occupant seated in the vehicle seat 85, 86, or 87 wears the seatbelt unit 88.

Therefore, at steps S305, S306, S307, and S308, an estimation can be made that the degree of damage to an occupant is high when the occupant does not wear the seatbelt unit 88. The emergency call can be more easily made. Therefore, when the vehicle 8 is in an accident or the like, the criticality of the emergency situation can be accurately determined and an emergency call can be made.

### Second Embodiment

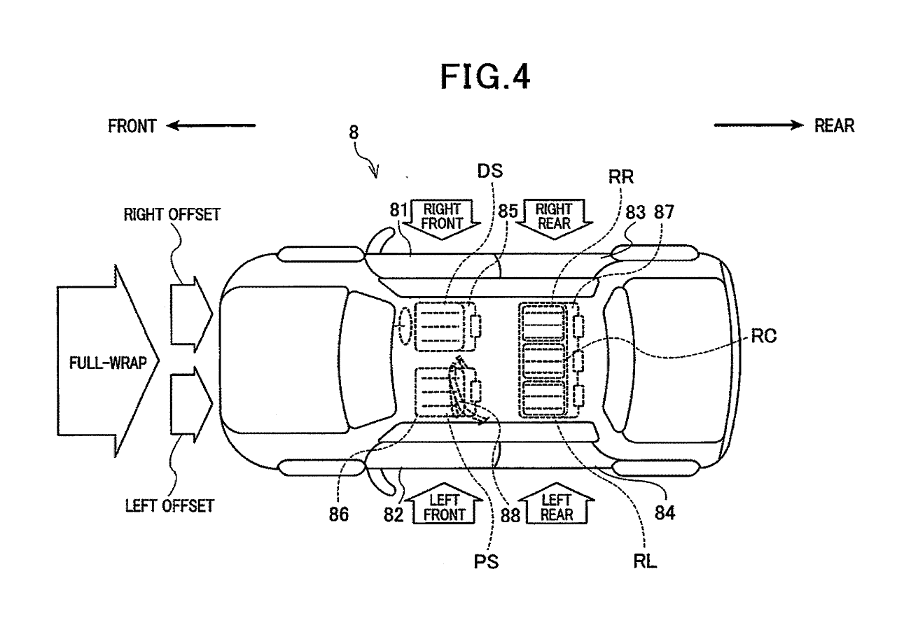

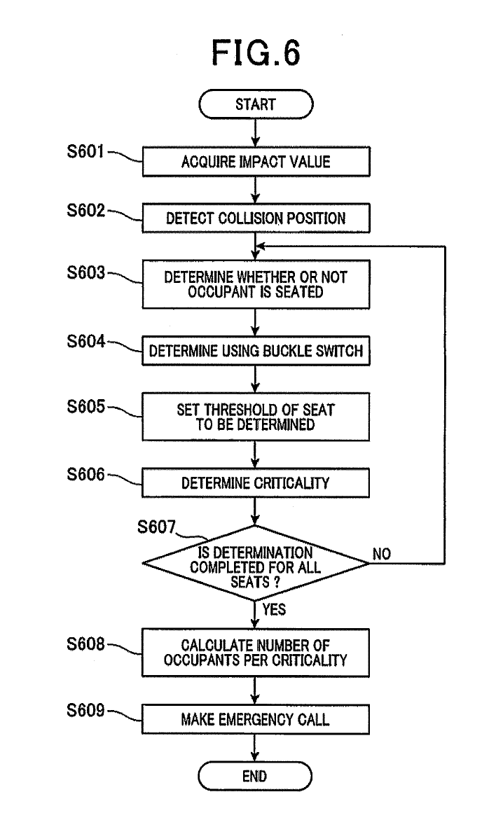

Next, the vehicle emergency call apparatus 1 according to a second embodiment will be described with reference to FIG. 4 to FIG. 6.

Here, only the differences between the first embodiment and the second embodiment will be described. Configurations in FIG. 4 that are the same as those in FIG. 1 are given the same reference numbers. In addition, although not shown in FIG. 4, the vehicle 8 according to the present embodiment is also provided with the acceleration sensors 2 and the occupant detection sensors 5 that are similar to those according to the first embodiment. The acceleration sensors 2 and the occupant detection sensors 5 are mounted in the same positions as those according to the first embodiment.

As shown in FIG. 4, according to the present embodiment, a collision position of the vehicle 8 (a position of the vehicle 8 at which impact is applied from outside of the vehicle 8) is detected based on the detection values from the acceleration sensors 2 during an accident or the like.

In FIG. 4, full-wrap (full-wrap collision) refers to when a collision occurs over the overall surface of the front portion of the vehicle 8. Right offset (driver-side offset collision) refers to when a collision occurs on the right half of the front portion of the vehicle 8. Left offset (occupant seat-side collision) is when a collision occurs on the left half of the front portion of the vehicle 8. The determination of full-wrap, right offset, or left offset is made based on one or a combination of the detection values of the acceleration sensors 2a, 2b, 2g, and the like.

Right front (driver-side front portion collision) refers to when a collision occurs on the driver-side door 81 of the vehicle 8. Left front (occupant seat-side front portion collision) refers to when a collision occurs on the occupant seat-side door 82 of the vehicle 8. Right rear (driver-side rear portion collision) refers to when a collision occurs on the right rear door 83 of the vehicle 8. Left rear (occupant seat-side rear portion collision) refers to when a collision occurs on the left rear door 84 of the vehicle 8. Determination of right front, left front, right rear, or left rear is made based on one or a combination of the detection values of the acceleration sensors 2c, 2d, 2e, 2f, and the like.

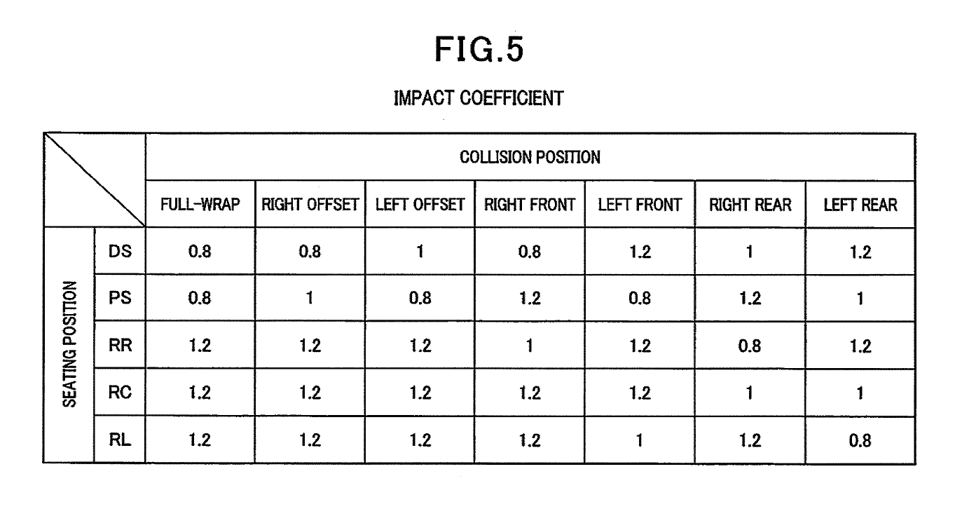

According to the present embodiment, an impact coefficient table, shown in FIG. 5, is generated based on combinations of the above-described collision positions of the vehicle 8 and the seating positions of the occupants. The impact coefficient table indicates the impact coefficient of each collision position for each of the occupants seated in the seating positions DS, PS, RR, RC, and RL. The impact coefficient is set to a smaller value as the estimated degree of damage to the occupant becomes larger. The impact coefficient table is stored in advance within the airbag controller 3.

Next, an emergency call method of the vehicle emergency call apparatus 1 according to the present embodiment will be described.

First, the airbag controller 3 detects the magnitude of the impact applied to the vehicle 8 from outside of the vehicle 8 based on the detection values from the acceleration sensors 2 (step S601). The airbag controller 3 then determines the collision position of the vehicle 8 (step S602).

Next, the airbag controller 3 determines, through the occupant detection sensor 5, whether or not an occupant is seated in the seating position DS, PS, RR, RC, or RL that is the determination subject (step S603). When determined that an occupant is not seated, the airbag controller 3 changes the determination subject to the next seating position DS, PS, RR, RC, or RL. When determined that an occupant is seated, the airbag controller 3 determines, through the buckle switch 4, whether or not the seated occupant wears the seatbelt unit 88 (step S604).

Then, the airbag controller 3 sets a threshold for the impact value based on whether or not the occupant wears the seatbelt unit 88, and the combination of the collision position of the vehicle 8 and the seating position DS, PS, RR, RC, or RL of the occupant (step S605).

According to the present embodiment, in a manner similar to that according to the first embodiment, the above-described threshold IMS1 (corresponding to the first threshold) is selected as the nominal value of the threshold when the occupant does not wear the seatbelt unit 88. The above-described threshold IMS2 (corresponding to the second threshold) is selected as the nominal value of the threshold when the occupant wears the seatbelt unit 88. In a manner similar to that according to the first embodiment, the nominal thresholds IMS1 and IMS2 are set so that IMS1<IMS2.

The selected nominal threshold IMS1 or IMS2 is multiplied by the impact coefficient. The impact coefficient is determined based on the impact coefficient table shown in FIG. 5, based on the combination of the collision position on the vehicle 8 and the seating position DS, PS, RR, RC, or RL of the occupant. The product of the multiplication serves as a final threshold.

For example, the occupant seated in the occupant seating PS that is the determination subject wears the seatbelt unit 88. The collision position is the right front. In this case, the final threshold is (IMS2×1.2). In addition, the occupant seated in the right rear seating RR does not wear the seatbelt unit 88. The collision position is the right rear. In this case, the final threshold is (IMS1×0.8). The final threshold is hereinafter collectively referred to as (IMS1×K) or (IMS2×K).

Here, the nominal thresholds IMS1 and IMS2, and the impact coefficients are set so that the final threshold satisfies the expression (IMS1×1.2<IMS2×0.8).

When the final threshold (IMS1×K) or (IMS2×K) is set, the airbag controller 3 makes the determination of “high criticality” or “low criticality” based on whether or not the impact value of the impact applied to the vehicle 8 is equal to or larger than the final threshold (IMS1×K) or (IMS2×K) (step S606).

Next, the airbag controller 3 determines whether or not the determination related to criticality has been completed for all seating positions DS, PS, RR, RC, and RL in the vehicle 8 (step S607). When determined that the determination related to criticality has not been completed for all seating positions DS, PS, RR, RC, and RL, the airbag controller 3 returns to step S603.

When determined that the determination related to criticality has been completed for all seating positions DS, PS, RR, RC, and RL, the airbag controller 3 calculates the number of occupants per criticality (step S608). When determined that there is even a single occupant for whom the determination “high criticality” has been made, among the determination results for the seating positions DS, PS, RR, RC, and RL, the airbag controller 3 makes an emergency call to the rescue center 9, via the external communication unit 6 (step S609). A notification of the number of occupants for whom the determination “high criticality” has been made is also given with the emergency call.

According to the present embodiment, the nominal threshold IMS1 or IMS2 is increased or decreased based on the combination of the collision position on the vehicle 8 and the seating position DS, PS, RR, RC, or RL of the occupant. The final threshold (IMS1×K) or (IMS2×K) is thereby set. As a result, the degree of damage to the occupant seated in the vehicle seat 85, 86, or 87 can be specifically estimated taking into consideration the combination of the collision position and seating position DS, PS, RR, RC, or RL. More detailed information can be provided to the rescue center 9 through the emergency call.

### Third Embodiment

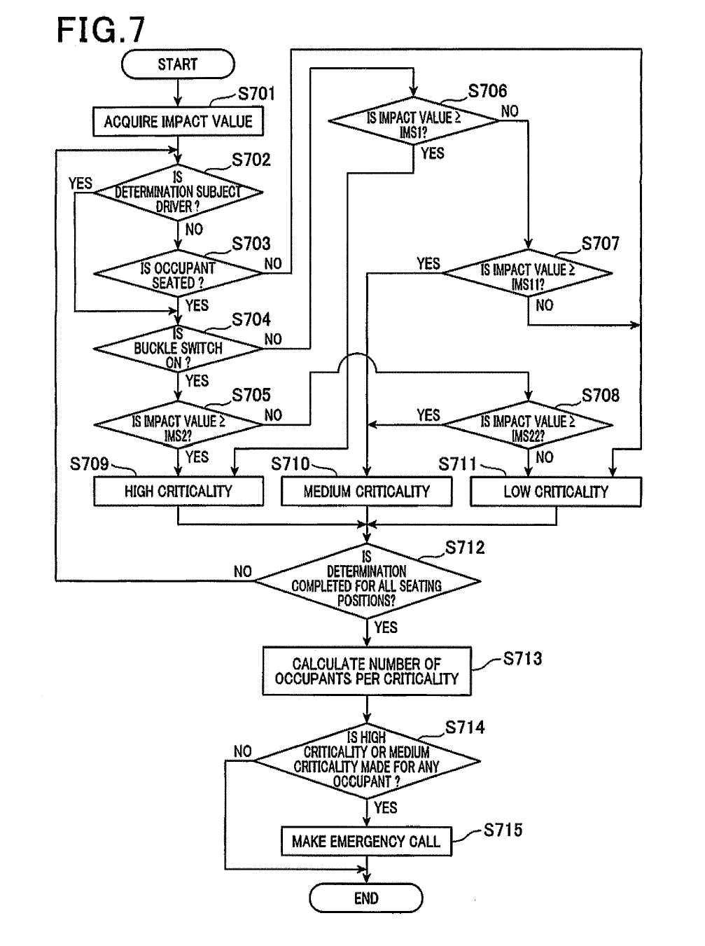

Next, the vehicle emergency call apparatus 1 according to a third embodiment will be described with reference to FIG. 7. Here, only the differences between the first embodiment and the third embodiment will be described. According to the present embodiment, the degree of damage to an occupant is determined so as to be classified into three levels: “high criticality”, “medium criticality”, and “low criticality”.

First, the airbag controller 3 determines, through the acceleration sensors 2, the magnitude of the impact applied to the vehicle 8 from outside of the vehicle 8 (step S701). Next, in a manner similar to that according to the first embodiment, the airbag controller 3 performs the processes at steps S702, 5703, and S704. Then, the airbag controller 3 proceeds to step S705 or S706.

When determined that the impact value of the impact applied to the vehicle 8 is lower than the threshold IMS2 at step S705, the airbag controller 3 proceeds to step S708. At step S708, the airbag controller 3 determines whether or not the impact value of the impact applied to the vehicle 8 is equal to or larger than a threshold IMS22.

When determined that the impact value of the impact applied to the vehicle 8 is equal to or larger than the threshold IMS22, the airbag controller 3 determines that the degree of damage to the occupant is “medium criticality” (step S710). When determined that the impact value of the impact applied to the vehicle 8 is lower than the threshold IMS22, the airbag controller 3 determines that the degree of damage to the occupant is “low criticality” (step S711).

In addition, when determined that that the impact value of the impact applied to the vehicle 8 is lower than the threshold IMS1 at step S706, the airbag controller 3 proceeds to step S707. At step S707, the airbag controller 3 determines whether or not the impact value of the impact applied to the vehicle 8 is equal to or larger than a threshold IMS11.

When determined that the impact value of the impact applied to the vehicle 8 is equal to or larger than the threshold IMS11, the airbag controller 3 determines that the degree of damage to the occupant is “medium criticality” (step S710). When determined that the impact value of the impact applied to the vehicle 8 is lower than the threshold IMS11, the airbag controller 3 determines that the degree of damage to the occupant is “low criticality” (step S711).

Here, the relationship of magnitude among the above-described thresholds IMS1, IMS11, IMS2, and IMS22 is set so that IMS11<IMS1<IMS22<IMS2. In addition, IMS11 and IMS22 may be increased and decreased within the above-described range based on the combination of the collision position of the vehicle 8 and seating position DS, PS, RR, RC, or RL.

The airbag controller 3 subsequently makes the determination of “high criticality”, “medium criticality”, or “low criticality” for each of the occupants seated in all seating positions DS, PS, RR, RC, and RL in the vehicle 8 (step S712). When the determination is completed, at step S713, the airbag controller 3 calculates the number of occupants for each criticality.

Next, at step S714, the airbag controller 3 determines whether or not there is an occupant for whom the determination “high criticality” or “medium criticality” has been made among the determination results. When determined that there is even a single occupant for whom the determination “high criticality” or “medium criticality” has been made among the determination results, the airbag controller 3 makes an emergency call to the rescue center 9 (step S715). Notification of the number of occupants for whom the determination “high criticality” or “medium criticality” has been made is given per criticality during the emergency call.

When determined that there is not even a single occupant for whom the determination “high criticality” or “medium criticality” has been made among the determination results, the airbag controller 3 does not make an emergency call to the rescue center 9 and ends the present flow (step S714). Other parts of the flow shown in FIG. 7 are the same as those shown in FIG. 3. Therefore, descriptions thereof are omitted.

According to the present embodiment, the degree of damage to an occupant is determined so as to be classified into three levels: “high criticality”, “medium criticality”, and “low criticality”. When there is even a single occupant for whom the determination “high criticality” or “medium criticality” has been made, the emergency call is made to the rescue center 9. Therefore, the degree of damage to an occupant seated in the vehicle seat 85, 86, or 87 can be estimated in further detailed. Even more detailed information can be provided to the rescue center 9.

In addition, the external communication unit 6 gives notification of the number of occupants for whom the determination “high criticality” or “medium criticality” has been made per criticality, when the emergency call is made. Therefore, the rescue center 9 that has received the call can specifically detect the degree of damage. The rescue center 9 can make sufficient preparations for the rescue operation in advance and carry out the operation with more efficiency.

### Other Embodiments

The present disclosure is not limited to the above-described embodiments. Modifications and expansions can be made as described below.

In the present disclosure, as the impact amount detector or detecting means for detecting the magnitude of the impact applied to the vehicle 8 from outside of the vehicle 8 during an accident or the like, a pressure sensor may be used instead of or in combination with the acceleration sensor 2. The pressure sensor may detect increase in pressure caused by compression in the internal space of the vehicle door 81, 82, 83, or 84 due to a collision.

In addition, as the seating detector or detecting means for detecting whether or not an occupant is seated on the vehicle seat 85, 86, or 87, a capacitance-type occupant detection sensor may be used in addition to the load sensor that includes a strain gauge.

In addition, as the seating detector for detecting whether or not an occupant is seated on the vehicle seat 85, 86, or 87, a charge-coupled device (CCD) camera may be used instead of or in combination with the occupant detection sensor. The CCD camera captures images of the occupant seated on the vehicle seat 85, 86, or 87.

In addition, as the belt-wearing detector for detecting whether or not an occupant wears a seatbelt, a CCD camera may be used instead of or in combination with the buckle switch 4. The CCD camera captures images of the occupant seated on the vehicle seat 85, 86, or 87.

In addition, when the build of each occupant is estimated based on the detection values from the occupant detection sensor 5, and the gender and age of the occupant are estimated using the CCD camera that captures images of the occupant, information related to gender, age, and build of each occupant may be provided when the emergency call is made to the rescue center 9.

In addition, the present disclosure can be applied to a vehicle that has a single row of seats or three rows of seats, or a vehicle having numerous rows of seats, such as a bus, in addition to a vehicle having two rows of seats.

What is claimed is:

1. A vehicle emergency call apparatus comprising:
an impact amount detector that detects an impact magnitude applied to a vehicle from outside of the vehicle;
a seating detector that detects whether or not at least one occupant is seated in at least one vehicle seat in the vehicle;
a call determining unit that determines whether or not a degree of damage to the occupant seated in the vehicle seat is a predetermined degree required for an emergency call to be made, based on the detected impact magnitude applied to the vehicle and a predetermined impact magnitude; and
a calling unit that makes an emergency call to a rescue center, if it is determined that the degree of damage to the at least one occupant is the predetermined degree required for the emergency call to be made or more, based on determination results of the call determining unit;
a belt-wearing detector that detects whether or not the at least one occupant seated in the at least one vehicle seat wears a seatbelt,
the call determining unit setting the predetermined impact magnitude to a first impact magnitude when the belt-wearing detector detects that the at least one occupant seated in the at least one vehicle seat does not wear the seatbelt, and setting the predetermined impact magnitude to a second impact magnitude when the belt-wearing detector detects that the at least one occupant seated in the at least one vehicle seat wears the seatbelt, the first impact magnitude being set to be smaller than the second impact magnitude.

2. The vehicle emergency call apparatus according to claim 1, wherein:
when the belt-wearing detector detects that the at least one occupant seated in the at least one vehicle seat does not wear the seatbelt, the call determining unit determines that the degree of damage is the predetermined degree required for an emergency call to be made, if the detected impact magnitude applied to the vehicle is equal to or larger than a first threshold that is set as the first impact magnitude;
when the belt-wearing detector detects that the at least one occupant seated in the at least one vehicle seat wears the seatbelt, the call determining unit determines that the degree of damage is the predetermined degree required for an emergency call to be made, if the detected impact magnitude applied to the vehicle is equal to or larger than a second predetermined threshold that is larger than the first threshold and is set as the second impact magnitude; and
the call determining unit increases or decreases the first predetermined threshold and the second predetermined threshold, based on a combination of a collision position of the vehicle and a seating position of the occupant seated in the vehicle seat.

3. The vehicle emergency call apparatus according to claim 1, wherein:
when the emergency call is made, the calling unit gives notification of the number of occupants to which the degree of damage is determined to be the predetermined degree required for the emergency call to be made.

4. The vehicle emergency call apparatus according to claim 2, wherein:
when the emergency call is made, the calling unit gives notification of the number of occupants to which the degree of damage is determined to be the predetermined degree required for the emergency call to be made.

5. The vehicle emergency call apparatus according to claim 1, wherein:
the belt-wearing detector comprises a buckle switch for the seatbelt.

6. The vehicle emergency call apparatus according to claim 2, wherein:
the belt-wearing detector comprises a buckle switch for the seatbelt.

7. The vehicle emergency call apparatus according to claim 3, wherein:
the belt-wearing detector comprises a buckle switch for the seatbelt.

8. The vehicle emergency call apparatus according to claim 4, wherein:
the belt-wearing detector comprises a buckle switch for the seatbelt.

9. A vehicle emergency call method comprising:
detecting, by an impact amount detector, an impact magnitude applied to a vehicle (8) from outside of the vehicle;
detecting, by a seating detector, whether or not at least one occupant is seated in at least one vehicle seat in the vehicle;
detecting, by a call determining unit, whether or not a degree of damage to the occupant seated in the vehicle seat is a predetermined degree required for an emergency call to be made, based on the detected impact magnitude applied to the vehicle and a predetermined impact magnitude;
making, by a calling unit, an emergency call to a rescue center, if it is determined that the degree of damage to the at least one occupant is the predetermined degree required for the emergency call to be made or more, based on determination results of the call determining unit;
detecting, by a belt-wearing detector, whether or not the at least one occupant seated in the at least one vehicle seat wears a seatbelt;
when the belt-wearing detector detects that the at least one occupant seated in the at least one vehicle seat does not wear the seatbelt, setting, by the call determining unit, the predetermined impact magnitude to a first impact magnitude; and
when the belt-wearing detector detects that the at least one occupant seated in the at least one vehicle seat wears the seatbelt, setting, by the call determining unit, the predetermined impact magnitude to a second impact magnitude, the first impact magnitude being set to be smaller than the second impact magnitude.
